(19) United States
(12) Patent Application Publication
(10) Pub. No.: US 2014/0360308 A1
(43) Pub. Date: Dec. 11, 2014

(54) MECHANICAL MANEUVERING SYSTEM

(71) Applicant: DONAL WALKER LUMSDEN, Houston, TX (US)

(72) Inventor: DONAL WALKER LUMSDEN, Houston, TX (US)

(21) Appl. No.: 14/301,138

(22) Filed: Jun. 10, 2014

Related U.S. Application Data
(60) Provisional application No. 61/833,113, filed on Jun. 10, 2013.

(51) Int. Cl. G05G 13/00

(52) U.S. Cl. CPC G05G 13/00
USPC 74/490.13

(57) ABSTRACT

A mechanical maneuvering system is configured to move an appendage in a first polar direction and a second polar direction. The mechanical maneuvering system has a housing base configured to accommodate a first bracket and a second bracket. A housing top is connected to the housing base and configured to accommodate a third bracket and a fourth bracket. A slide anchor is connected to each bracket and a different wire. Moving a first slide anchor in a first direction manipulates the appendage clockwise in the first polar direction. Moving a second slide anchor in a second direction manipulates the appendage counterclockwise in the first polar direction. Moving a third slide anchor in the third direction moves the appendage clockwise in the second polar direction. Moving a fourth slide anchor in a fourth direction manipulates the appendage counterclockwise in the second polar direction.

### RELATED APPLICATION

This application claims priority to provisional patent application U.S. Ser. No. 61/833,113 filed on Jun. 10, 2013, the entire contents of which is herein incorporated by reference.

### BACKGROUND

Embodiments of the present invention relate to a bendable appendage, such as a steerable catheter, that needs to be able to be manipulated into bending in multiple directions from a single point. However, prior to embodiments of the disclosed invention, other mechanical systems did not allow complex bends to be controlled from a single point. To wit, robot systems required engaging a catheter at multiple points, such as four spools of wire, to control a bend in multiple directions. Embodiments of the disclosed invention, solve this problem and allow a surgeon, dentist, plumber, or driller to control the angle of bend of an instrument in any direction from a single point, such as one finger.

### SUMMARY

A mechanical maneuvering system can be configured to move an appendage in a first polar direction and a second polar direction. The mechanical maneuvering system can include a housing base configured to accommodate a first bracket and a second bracket. The first bracket can be configured to maneuver in a first direction and the second bracket can be configured to maneuver in a second direction. A housing top can be connected to the housing base and configured to accommodate a third bracket and a fourth bracket. The third bracket can be configured to maneuver in a third direction. The fourth bracket can be configured to maneuver in a fourth direction.

A first slide anchor can be connected to the first bracket and further attached to a first wire attached to the appendage. Moving the first slide anchor in the first direction can manipulate the appendage clockwise in the first polar direction.

A second slide anchor can be connected to the second bracket and further connected to a second wire attached to the appendage. Moving the second slide anchor in the second direction manipulates the appendage counterclockwise in the first polar direction.

A third slide anchor connected to the third bracket and further attached to a third wire attached to the appendage. Moving the third slide anchor in the third direction moves the appendage clockwise in the second polar direction.

A fourth slide anchor connected to the fourth bracket and further attached to a fourth wire attached to the appendage. Moving the fourth slide anchor in the fourth direction manipulates the appendage counterclockwise in the second polar direction.

In some embodiments, a first housing base outer slide bracket and a second housing base outer slide bracket can be mechanically coupled to the housing base. The first housing base outer slide bracket and the second housing base outer slide bracket can permit free movement of the first bracket and the second bracket between their distal points.

In some embodiments, a first housing base inner bracket can be mechanically coupled to the housing base. The first housing base inner bracket can be configured to allow movement of the first bracket until a point where the movement is stopped. A first housing base inner bracket allows a first slide anchor to move freely in a linear direction until a point where the movement is stopped. A second housing base inner bracket can be mechanically coupled to the housing base. The second housing inner base bracket can be configured to allow the second bracket to move until a point where the movement is stopped. A second housing base inner bracket allows a second slide anchor to move freely in a linear direction until a point where the movement is stopped.

In some embodiments, a first housing top outer slide bracket and a second housing top outer slide bracket can be mechanically coupled to the housing top. The first housing top outer slide bracket and the second housing top outer slide bracket can permit free movement of the first bracket and the second bracket between their distal points.

In some embodiments, a first housing top inner bracket can be mechanically coupled to the housing top. The first housing top inner bracket can be configured to allow movement of the first bracket until a point where the movement is stopped. A first housing top inner bracket allows a third slide anchor to move freely in a linear direction until a point where the movement is stopped. A second housing top inner bracket can be mechanically coupled to the housing top. A second housing top inner bracket can be configured to allow the second bracket to move until a point where the movement is stopped. A second housing top inner bracket allows a fourth slide anchor to move freely in a linear direction until a point where the movement is stopped.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of the invention.

FIG. 2 is a perspective view of the invention and omitting several components for illustrative clarity.

FIG. 3 is a perspective view of the housing top.

FIG. 4 is a perspective view of the housing base.

FIG. 5 is a perspective view of the bracket.

FIG. 6 is a top view of the bracket.

FIG. 7 is a perspective view of a slide anchor.

FIG. 8 is a perspective view of the finger pad.

FIG. 9 is a schematic view of the wire assembly.

FIG. 10 is a schematic view of the appendage.

### DETAILED DESCRIPTION OF CERTAIN EMBODIMENTS

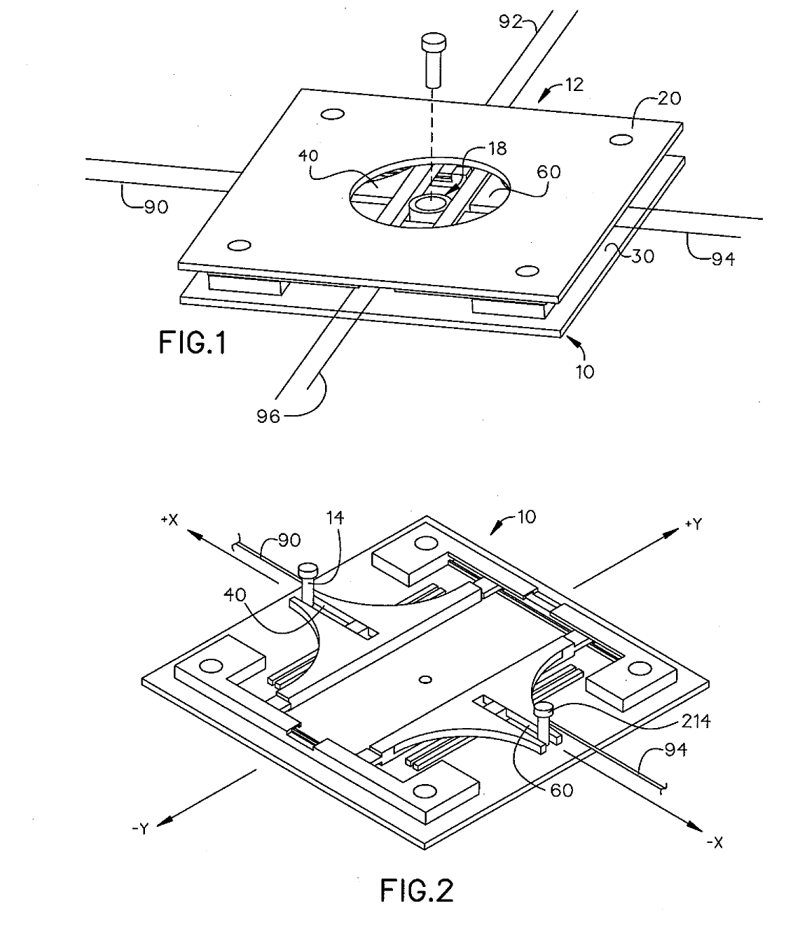

By way of example, and referring to FIG. 1, one embodiment of mechanical maneuvering system 10 comprises housing top 20 joined to housing base 30. Housing base 30 is attached to finger pad 18. Finger pad 18 enables a user to maneuver the brackets as indicated below within mechanical maneuvering system 10.

Turning to FIG. 2, housing base 30 is connected to first bracket 40 which is configured to maneuver in a first direction +X. First bracket 40 is further mechanically coupled to first slide anchor 14. First slide anchor 14 is attached to first wire 90. Housing base 30 is connected to second bracket 60 which is configured to maneuver in a second direction −X. Second bracket 60 is further mechanically coupled to second slide anchor 214. Second slide anchor 214 is attached to second wire 94.

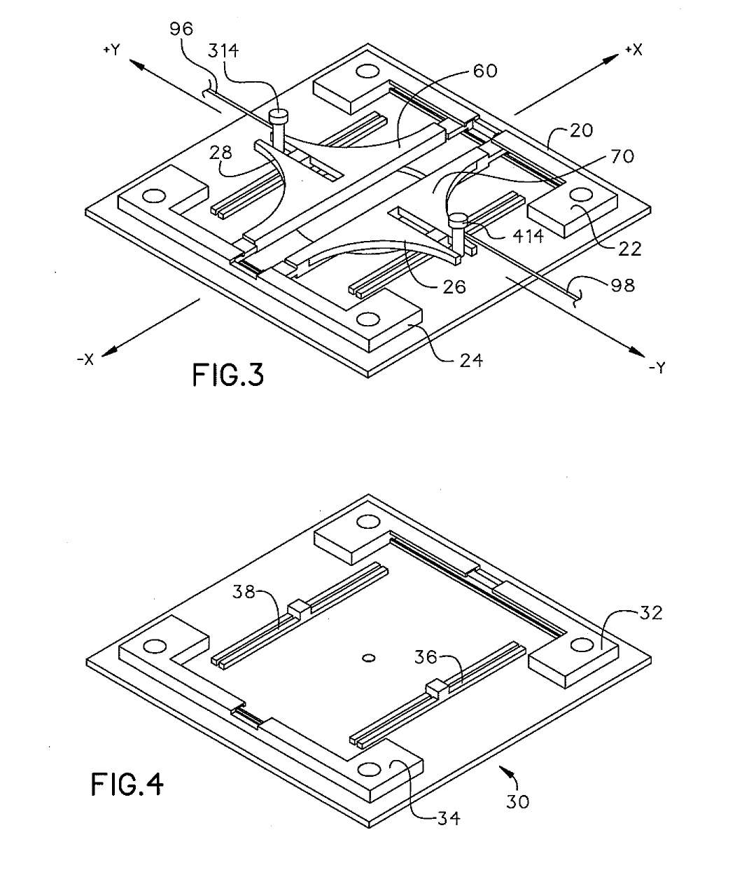

Turning to FIG. 3, housing top 20 is connected to third bracket 70 which is configured to maneuver in a third direction −Y. Third bracket 70 is further mechanically coupled to third slide anchor 214. Third slide anchor 214 is attached to third wire 96. Housing top 20 is connected to fourth bracket 80 which is configured to maneuver in a fourth direction +Y. Fourth bracket 80 is further mechanically coupled to fourth slide anchor 414. Fourth slide anchor 414 is attached to fourth wire 98.

Housing top 20 is mechanically coupled to first housing top outer slide bracket 22 and second housing top outer slide bracket 24. First housing top outer slide bracket 22 and second housing top outer slide bracket 24 permit free movement of third bracket 70 and fourth bracket 80 between their distal points.

Housing top 20 is further mechanically coupled to first housing top inner bracket 26. First housing top inner bracket 26 is configured to allow movement of third bracket 70 until a point where movement is stopped. Housing top 20 is further mechanically coupled to second housing top inner bracket 28. Second housing top inner bracket 28 is configured to allow movement of fourth bracket 80 until a point where movement is stopped.

Turning to FIG. 4, housing base 30 is mechanically coupled to first housing base outer slide bracket 32 and second housing base outer slide bracket 34. First housing base outer slide bracket 32 and second housing base outer slide bracket 34 permit free movement of first bracket 40 and second bracket 60 between their distal points.

Housing base 30 is further mechanically coupled to first housing base inner bracket 36. First housing base inner bracket 36 is configured to allow movement of first bracket 40 until a point where movement is stopped. Housing base 30 is further mechanically coupled to second housing base inner bracket 38. Second housing base inner bracket 38 is configured to allow movement of second bracket 60 until a point where movement is stopped.

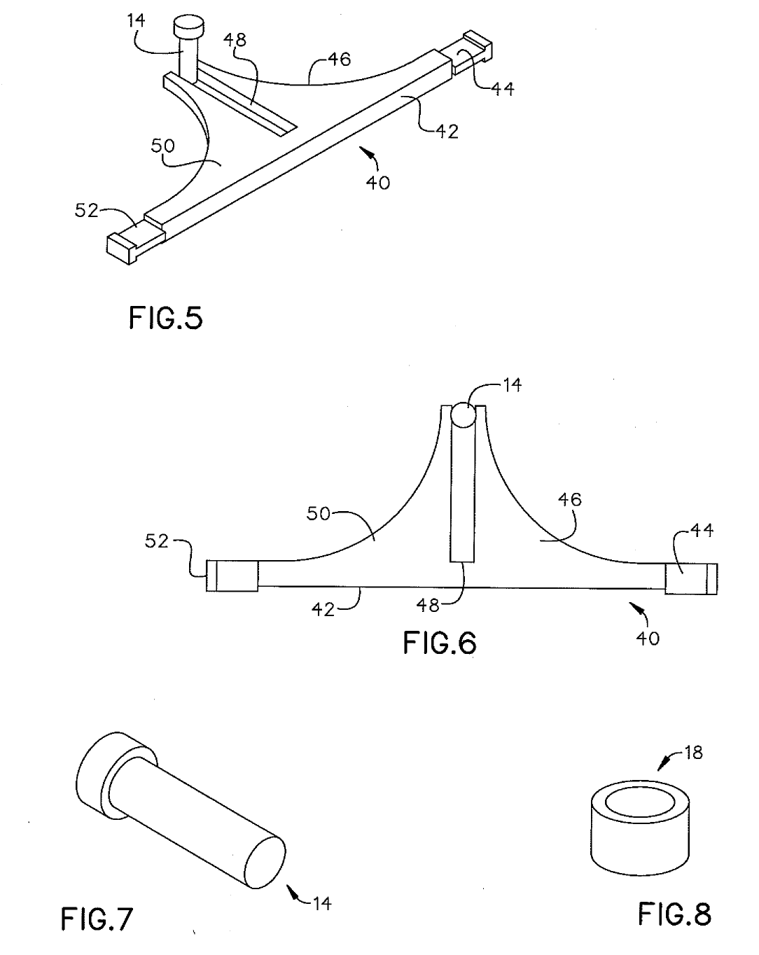

First bracket 40, second bracket 60, third bracket 70 and fourth bracket 80 are all constructed substantially the same way as shown in FIG. 5 and FIG. 6. For instance, each bracket 40 comprises bracket base 42 mechanically coupled to first slide bracket brace 44 and second slide bracket brace 52. First slide bracket brace 44 is immediately adjacent to first rounded member 46. First rounded member 46 is truncated by inner housing stop 38 which is configured to catch an inner housing base bracket to stop movement of bracket 40. Similarly, second slide bracket brace 52 is immediately adjacent to second rounded member 50. Second rounded member 50 is truncated by inner housing stop 38.

Turning to FIG. 7, slide anchor 14 takes the shape of a first cylinder covered, in part by a second cylinder. The second cylinder is at one distal point of the first cylinder giving the user the ability to manipulate the first cylinder by manipulating the second cylinder. Turning to FIG. 8, finger pad 18 fits within of mechanical maneuvering system 10.

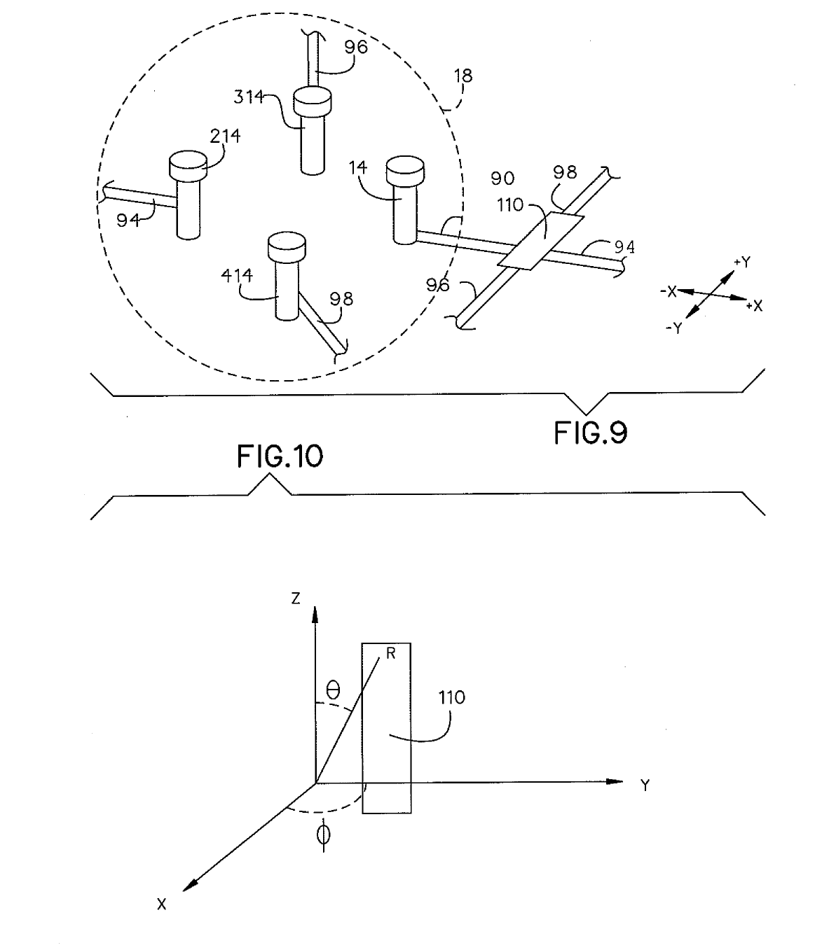

As shown in FIG. 9 and FIG. 10, each slide anchor 14, 214, 314 or 414 is mechanically coupled to first wire 90, second wire 94, third wire 96 and fourth wire 98. The wires are attached to a distal point of appendage 110. The wires are each initially taut on appendage 110. When first slide anchor 14 is moved in first direction +X, first wire 90 manipulates appendage 110 clockwise in the first polar direction Φ. When second slide anchor 214 is moved in second direction −X, second wire 94 manipulates appendage 110 counterclockwise in the first polar direction Φ. When third slide anchor 314 is moved in third direction −Y, third wire 96 manipulates appendage 110 clockwise in the second polar direction θ. When fourth slide anchor 414 is moved in fourth direction +Y, fourth wire 98 manipulates appendage 110 counterclockwise in the second polar direction θ. In this embodiment, r is of a constant length, though by bending a distal point of appendage 100, R can vary some amount from the origin.

Each wire should be made of fairly rigid material such that minor manipulations in force cause expansion or contraction to result in some plastic deformation. This causes the appendage 110 to be turned and manipulated requiring only increased pressure on four wires.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A mechanical maneuvering system, configured to move an appendage in a first polar direction and a second polar direction; the mechanical maneuvering system comprising:
a housing base configured to accommodate a first bracket and a second bracket; wherein the first bracket is configured to maneuver in a first direction and the second bracket is configured to maneuver in a second direction;
a housing top, connected to the housing base and configured to accommodate a third bracket and a fourth bracket; wherein the third bracket is configured to maneuver in a third direction; and the fourth bracket is configured to maneuver in a fourth direction;
a first slide anchor connected to the first bracket and further attached to a first wire attached to the appendage; wherein moving the first slide anchor in the first direction manipulates the appendage clockwise in the first polar direction;
a second slide anchor connected to the second bracket and further connected to a second wire attached to the appendage; wherein moving the second slide anchor in the second direction manipulates the appendage counterclockwise in the first polar direction;
a third slide anchor connected to the third bracket and further attached to a third wire attached to the appendage; wherein moving the third slide anchor in the third direction moves the appendage clockwise in the second polar direction; and
a fourth slide anchor connected to the fourth bracket and further attached to a fourth wire attached to the appendage; wherein moving the fourth slide anchor in the fourth direction manipulates the appendage counterclockwise in the second polar direction.

2. The mechanical maneuvering system of claim 1, further comprising: a first housing base outer slide bracket and a second housing base outer slide bracket mechanically coupled to the housing base; wherein the first housing base outer slide bracket and the second housing base outer slide bracket permit free movement of the first bracket and the second bracket between their distal points.

3. The mechanical maneuvering system of claim 2, further comprising:
a first housing base inner bracket mechanically coupled to the housing base; wherein the first housing base inner bracket is configured to allow movement of the first bracket until a point where the movement is stopped; and
a second housing base inner bracket mechanically coupled to the housing base; wherein the second housing inner base bracket is configured to allow the second bracket to move until a point where the movement is stopped.

4. The mechanical maneuvering system of claim 3, further comprising: a first housing top outer slide bracket and a second housing top outer slide bracket mechanically coupled to the housing top; wherein the first housing top outer slide bracket and the second housing top outer slide bracket permit free movement of the first bracket and the second bracket between their distal points.

5. The mechanical maneuvering system of claim 4, further comprising:
a first housing top inner bracket mechanically coupled to the housing top; wherein the first housing top inner bracket is configured to allow movement of the third bracket until a point where the movement is stopped; and
a second housing top inner bracket mechanically coupled to the housing top; wherein the second housing top inner bracket is configured to allow the fourth bracket to move until a point where the movement is stopped.
